(19) United States
(12) Patent Application Publication
(10) Pub. No.: US 2003/0091830 A1
(43) Pub. Date: May 15, 2003

(54) Powder coating material and functional coatings for high long-term service temperature

(76) Inventors: Werner Blomer, Ochtrup (DE); Christopher Hilger, Munster (DE); Dietmar Thomas, Hilden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/209,076

(22) Filed: Jul. 31, 2002

(30) Foreign Application Priority Data
Oct. 25, 2001 (DE) 101 52 829.9

(51) Int. Cl. B32B 15/08

(52) U.S. Cl. 428/418

(57) ABSTRACT

A powder coating material comprising, based on the coating material, (A) from 40 to 65% by weight of at least one solid epoxy resin which is polyfunctional in respect of thermal crosslinking by way of the epoxide groups and has an epoxide equivalent weight of from 380 to 420 g/equ., an ICI melt viscosity at 150° C. of from 2800 to 5000 mPas, and a softening point of from 95 to 105° C., (B) from 15 to 35% by weight of at least one solid, linear epoxy resin based on bisphenol A, AD and/or F, having a functionality in respect of thermal crosslinking by way of the epoxide groups of not more than 2, (C) from 15 to 30% by weight of an inorganic filler and (D) from 1 to 10% by weight of at least one hardener; and its use for producing functional coatings for substrates for high long-term service temperatures.

### CROSS-REFERENCE TO RELATED APPLICATIONS

The present application claims priority to German Patent Application 10152829.9, which was filed on Oct. 25, 2001.

The present invention relates to a new powder coating material. The present invention also relates to new functional coatings for high long-term service temperatures of substrates, particularly steel pipes.

Powder coating material which give coatings having a glass transition temperature Tg of more than 120° C. and which are therefore suitable for use at high long-term service temperatures are known from the Dow Plastics product information literature D.E.R. 6508, February 2000.

The powder coating materials comprise the solid epoxy resin D.E.R. 6508 having an epoxide equivalent weight of from 380 to 420 g/equ., and an ICI melt viscosity at 150° C. of from 2800 to 5000 mPas, and a softening point of from 95 to 105° C.

The following formulations are proposed in the product information literature:

1. Formulation 1

77.6% by weight D.E.R. 6508,

2.4% by weight amine hardener (Casamid® 783 from Thomas Swan),

5% by weight titanium dioxide,

14% by weight barium sulfate, and

1% by weight BYK® 360P (polyacrylate additive from Byk Chemie).

Glass transition temperature Tg of the coating:

161° C.

2. Formulation 2

46.6% by weight D.E.R. 6508

31% by weight D.E.R. 624U (epoxy-modified novolak resin),

2.4% by weight Casamid® 783,

5% by weight titanium dioxide,

14% by weight barium sulfate, and

1% by weight BYK® 360P.

Glass transition temperature Tg of the coating:

143° C.

3. Formulation 3

50.4% by weight D.E.R. 6508,

29.2% by weight phenolic hardener (D.E.H. 85 from Dow),

0.4% by weight 2-methylimidazole,

5% by weight titanium dioxide,

14% by weight barium sulfate, and

1% by weight BYK® 360P.

Glass transition temperature Tg of the coating:

126° C.

The known coatings, accordingly, have glass transition temperatures Tg which would appear to render them suitable for use at high long-term service temperatures.

Their flexibility and the amount of fillers and inorganic pigments they contain, however, still leave something to be desired. High flexibility of the coatings, however, makes a significant contribution to their mechanical stability, which is of great importance especially with regard to the laying of coated pipes, as takes place, for example, in the construction of pipelines. And a high level of fillers and inorganic pigments increases the abrasion resistance and the scratch resistance of the coatings reduces the costs for the base materials.

It is an object of the present invention to provide a new powder coating material which no longer has the disadvantages of the prior art but which instead provides functional coatings for substrates of high long-term service temperatures which are flexible, abrasion resistant, scratch resistant, water resistant, and have a high corrosion protection effect and withstand a relatively high level of inorganic pigments and fillers without important performance properties suffering as a result. On the contrary, the relatively high level of inorganic pigments and fillers ought to impact positively on the profile of properties of the new coatings.

The invention accordingly provides the new powder coating material comprising, based on the coating material,

(A) from 40 to 65% by weight of at least one solid epoxy resin which is polyfunctional in respect of thermal crosslinking by way of the epoxide groups and has an epoxide equivalent weight of from 380 to 420 g/equ., an ICI melt viscosity at 150° C. of from 2800 to 5000 mPas, and a softening point of from 95 to 105° C.,

(B) from 15 to 35% by weight of at least one solid, linear epoxy resin based on bisphenol A, AD and/or F, having a functionality in respect of thermal crosslinking by way of the epoxide groups of not more than 2,

(C) from 15 to 30% by weight of an inorganic filler and

(D) from 1 to 10% by weight of at least one hardener.

In the text below, the new powder coating material is referred to as the ,,coating material of the invention”.

The invention further provides the new coatings for substrates for high long-term service temperatures which can be produced by thermal crosslinking of the coating material of the invention and which are referred to below as ,,coatings of the invention”.

In the light of the prior art it was surprising and unforeseeable for the skilled worker that the object on which the present invention was based could be achieved by means of the coating material of the invention and of the coatings of the invention. A particular surprise was that by combining the polyfunctional solid epoxy resin (A) with the not more than difunctional solid epoxy resin (B) it was possible to increase significantly the fraction of inorganic fillers (C) and inorganic pigments (D) without detriment to the performance properties of the coatings of the invention. On the contrary, the coatings of the invention had a glass transition temperature Tg and high flexibility and were outstandingly suitable for use at high long-term service temperatures. Owing to their very good profile and performance properties, the coatings of the invention were especially suitable for the coating of steel pipes for pipelines used to convey hot fluids.

The first essential constituent of the coating material of the invention is at least one solid epoxy resin (A) which is polyfunctional in terms of thermal crosslinking by way of the epoxide groups. ,,Polyfunctional” means that the epoxy resin (A) has a functionality of >2. The epoxy resin (A) has an epoxide equivalent weight of from 380 to 420 g/equ., an ICI melt viscosity at 150° C. of from 2800 to 5000 mPas, and a softening point of from 95 to 105° C. In the coating material of the invention it is present in an amount of from 40 to 65° C., more preferably from 40 to 60%, and in particular from 42 to 55% by weight, based in each case on the coating material of the invention.

The epoxy resins (A) are customary and known compounds and are sold, for example, under the brand name D.E.R.® 6508 by Dow Plastics.

The second essential constituent of the coating material of the invention is at least one solid linear epoxy resin (B), based on bisphenol A, AD and/or F, in particular based on bisphenol A. In respect of thermal crosslinking by way of the epoxide groups, the epoxy resins (B) have a functionality of not more then 2. In the coating material of the invention they are present in an amount of from 15 to 35 %, preferably from 16 to 34%, and in particular from 18 to 32% by weight, based in each case on the coating material of the invention.

It is preferred to use oligoglycidyl or polyglycidyl ethers of the aforementioned bisphenols, particularly of bisphenol A. As is known, these epoxy resins (B) may be prepared by reacting epichlorohydrin with the bisphenols. Examples of suitable epoxy resins (B) are described, for example, in the French patent application FR 2 394 590 A, page 4 lines 20 to 36, in the Japanese patent H5-63307 B2, or in Römpp Lexikon Lacke und Druckfarben, Georg Thieme Verlag, Stuttgart, N.Y., 1998, ,,epoxy resins”, pages 196 and 197.

The third essential constituent of the coating material of the invention is at least one inorganic filler (C). In the coating material of the invention it is used in an amount of from 15 to 30%, preferably from 15 to 28%, and in particular from 15 to 25% by weight, based in each case on the coating material of the invention.

Examples of suitable inorganic fillers (C) are chalk, calcium sulfates, barium sulfate, silicates such as talc, mica or kaolin, crystalline silicas, as are known, for example, from the European patent EP 693 003 B1, page 3 lines 26 to 39, oxides such as aluminum hydroxide or magnesium hydroxide, and nanoparticles based on silica, alumina, aluminum oxide hydrate, or zirconium oxide. For further details, refer to Römpp Lexikon Lacke und Druckfarben, Georg Thieme Verlag, 1998, pages 250 ff., ,,fillers”. Preferably, barium sulfate is used.

The coating material of the invention contains at least one hardener (D) in an amount of from 1 to 10%, preferably from 1.5 to 5%, and in particular from 2 to 4% by weight, based in each case on the coating material of the invention.

The hardener (D) may comprise customary and known phenolic hardeners (D), such as are known, for example, from the American patent U.S. Pat. No. 6,096,807 A, column 2 lines 21 to 45, or the European patent EP 0 693 003 B1, page 2 line 59 to page 3 line 10.

It is also possible, however, to use customary and known amine-type hardeners (D), such as are known, for example, from the textbook by Johan Bieleman, ,,Lackadditive” [Additives for coatings], Wiley-VCH, Weinheim, N.Y., 1998, ,,7.2.4.2 Epoxy-amine systems”, pages 265 to 267.

The coating material of the invention may further comprise at least one inorganic pigment (E) preferably in an amount of from 0.5 to 10%, more preferably from 1 to 6%, and in particular from 1.5 to 5% by weight, based in each case on the coating material of the invention.

Examples of suitable inorganic pigments (E) are white pigments, such as titanium dioxide, zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate. Preference is given to using titanium dioxide, together if desired with iron oxide pigments.

Furthermore, the coating material of the invention may comprise at least one typical powder coatings additive (F) preferably in an amount of from 0.01 to 5% by weight, based on the coating material of the invention.

Examples of suitable typical powder coatings additives (F) are catalysts for phenolic curing, as described for example in the European patent EP 0 693 003 B1, page 3 lines 11 to 25, and catalysts for amine curing, as known, for example, from the textbook by Johan Bieleman, ,,Lackadditive” [Additives for coatings], Wiley-VCH, Weinheim, N.Y., 1998, ,,7.2.4.2 Epoxy-amine systems”, pages 265 to 267. The catalysts (F) may already be present in the commercial hardeners (D) used.

Further examples of suitable additives (F) are leveling agents, such as polyacrylates, slip additives, free-flow aids, and devolatilizers, such as benzoin.

The coating materials of the invention are prepared by known methods (cf., e.g., the BASF Lacke+Farben AG product information literature ,,Pulverlacke” [powder coating materials], 1990, and the BASF Coatings AG brochure ,,Pulverlacke fur industrielle Anwendungen” [powder coating materials for industrial applications], January 2000, pages 26 and 27) by homogenizing and dispersing using, for example, an extruder, screw compounder, and the like. Following preparation of the powder coating materials, they are adjusted to the desired particle size distribution by milling and, where appropriate, by sieving and classifying. For milling it is possible to use a grinding aid, such as Aerosil. The particle size of the coating materials of the invention may vary widely and is guided primarily by the intended application. The particle sizes are preferably between 10 and 500 μm, more preferably between 20 and 400 μm, with particular preference between 25 and 300 μm, and in particular from 30 to 200 μm.

The coating material of the invention is outstandingly suitable for producing the coatings of the invention by thermal crosslinking.

The application of the coating materials of the invention to the substrates has no special features in terms of its method but instead takes place by means of customary and known apparatus and techniques, such as are described, for example, in the BASF Lacke+Farben AG product information literature ,,Pulverlacke”, 1990, the BASF Coatings AG brochure ,,Pulverlacke fur industrielle Anwendungen”, January 2000, pages 26 and 27, or the American patent U.S. Pat. No. 6,096,807 A, column 3 lines 44 to 60.

Nor does the thermal curing of the applied coating material of the invention have any special features in terms of its method; instead it takes place, for example, using gas ovens. Prior to the application of the coating material of the invention, however, substrates are preferably heated to temperatures at which the applied coating material of the invention melts and crosslinks. Where substrates made of metals, particularly of iron, are used, it is also possible to employ inductive heating. Preference is given to employing crosslinking temperatures of from 150 to 260° C., more preferably from 160 to 240° C., and in particular from 180 to 240° C. (cf. also the American patent U.S. Pat. No. 6,096,807 A, column 3 lines 44 to 60).

On the basis of their advantageous performance properties, the coatings of the invention may be put to numerous end uses, as described, for example, in ,,Coatings Partner—The magazine of BASF Coatings—Powder Coatings Special”, 1/2000.

With particular preference, the coatings of the invention are used to coat steel pipes, especially steel pipes for producing pipelines.

The coatings of the invention have glass transition temperatures Tg of preferably from 130 to 150° C., more preferably from 130 to 145° C., and in particular from 130 to 140° C. As a result, they are readily able to withstand long-term service temperatures of from 80 to 130° C. without adverse affect on their high mechanical stability, flexibility, water stability, adhesion, or corrosion protection effects.

The coatings of the invention may be single-ply. They are preferably from 250 to 1000 μm, more preferably from 300 to 900 μm, and in particular from 350 to 900 μm in thickness.

Alternatively, the coatings of the invention may form the primer of a multi-ply coating system composed, for example, of a primer and at least one coat, preferably at least two coats, selected from the group consisting of adhesion promoter coats, polyolefin coats, insulating polyurethane coats, and coats producible from other, customary and known, powder coating materials based on epoxy resins. Coatings of this kind are used preferably for coating pipelines. For example, the coating of the invention may be composed of the primer, an adhesion promoter coat, and a polyolefin coat, as disclosed by the European patent EP 0 693 003 B1, especially page 4 lines 21 to 48, or the international patent application WO 92/03234 A, page 6 line 21 to page 11 line 30 and page 11 line 33 to page 21 line 6 in conjunction with FIG. 1.

The steel pipes provided with a coating of the invention, especially the pipelines of the invention, readily withstand high long-term service temperatures without suffering adverse effects on their high mechanical stability, flexibility, water stability, adhesion, and corrosion protection effect under service conditions in the soil. The pipelines of the invention therefore have a particularly long service life.

### EXAMPLES

### Examples 1 to 4

The Preparation of the Inventive Coating Materials 1 to 4 and of the Inventive Coatings 1 to 4

To prepare the inventive coating materials 1 to 4, their respective constituents (A), (B), (C), (D), (E), and (F) were mixed in the amounts indicated in Table 1, extruded, milled, and sieved, so as to give a particle size and a particle size distribution such as are commonly used with powder coating materials for coating steel pipes.

TABLE 1
Composition of the inventive coating materials 1 to 4

Examples:

| Ingredient | 1 | 2 | 3 | 4 |
|---|---|---|---|---|
| DOW D.E.R. 6508^{a)} | 53.16 | 48.3 | 43.4 | 43.4 |
| Epikote ® 1007^{b)} | 20 | 25 | 30 | 30 |
| Grilonit ® H 88071^{c)} | 3.04 | 2.9 | 2.8 | — |
| Epikure ® 143FF^{d)} | — | — | — | 2.8 |
| Blanc Fixe ® N^{e)} | 20 | 20 | 20 | 20 |
| Titan Rutil R 900^{f)} | 2 | 2 | 2 | 2 |
| Bayferrox ® 920^{g)} | 1 | 1 | 1 | 1 |
| Byk ® 360 P^{h)} | 0.8 | 0.8 | 0.8 | 0.8 |
| Density (g/cm³)ⁱ⁾ | 1.46 | 1.46 | 1.46 | 1.46 |

^{a)}polyfunctional solid epoxy resin; epoxide equivalent weight: 380 to 420 g/equ.; melt viscosity at 150° C.: 2800 to 5000 mPas; softening point: from 95 to 105° C.;
^{b)}commercial solid linear epoxy resin based on bisphenol A, from Shell;
^{c)}commercial amine-type hardener from Grilon;
^{d)}commercial amine-type hardener from Shell;
^{e)}barium sulfate filler;
^{f)}commercial titanium dioxide pigment;
^{g)}commercial iron oxide pigment from Bayer AG;
^{h)}commercial additive based on polyacrylate, from Byk Chemie;
ⁱ⁾density meter AccuPyk 1300

The inventive coating 1 was prepared from coating material 1, the inventive coating 2 from coating material 2, the inventive coating 3 from coating material 3, and the inventive coating 4 from coating material 4.

The inventive coating materials 1 to 4 were outstandingly suitable for coating steel pipes for pipelines. To this end, pipes of diameter 300 mm and wall thickness 12 mm were blasted to SA 3 state in a blast unit. The depth of roughness was 50 μm. The pipes were subsequently heated to 230° C. using an induction coil. Coating materials 1 to 4 were applied electrostatically with a film thickness of about 500 μm and cured. No problems occurred during either application or curing.

The gel time, the Erichsen cupping bending on the bench edge and in the bending shoe, the CD test, water absorption, the impact test, and the gloss and leveling were carried out/determined on the basis of suitable coated test panels. The glass transition temperature Tg was measured by means of differential thermoanalysis. The results are compiled in Table 2.

TABLE 2
the key performance properties of the inventive coatings 1 to 4

| | Example: | | | |
|---|---|---|---|---|
| Properties | 1 | 2 | 3 | 4 |
| Gel time (180° C.) (s)^{a)} | 52 | 53 | 52 | 43 |
| Erichsen cupping and | | | | |
| bending on bench edge^{b)} | | | | |
| on 0.5 mm steel sheet; | | | | |
| Curing conditions: | | | | |
| 3 min/160° C. | 0.2 ∘ | 0.2 ∘ | 0.2 ∘ | 0.2 ∘ |
| 6 min/160° C. | 0.7 ∘ | 0.7 ∘ | 0.7 ∘ | 0.7 ∘ |
| 9 min/160° C. | 4.8 x | 4.8 x | 5.7 x | 6.0 x |
| 12 min/160° C. | 6.5 x | 6.5 x | 7.0 x | 7.5 x |
| 15 min/160° C. | 7.5 + | 7.5 + | 7.7 + | 6.9 + |
| Glass | | | | |
| transition temperature | | | | |
| Tg (° C.) | 139.34 | 137.18 | 133.53 | 133.21 |
| Film thickness (μm) | 70 to 82 | 76 to 86 | 77 to 95 | 75 to 86 |
| Gloss 60° (units) | 100 | 100 | 100 | 98 |
| Leveling (curing | moderate | moderate | moderate | Moderate |
| conditions: 10 min/ | 3 | 3 | 3 | 3 |
| 180° C.) | | | | |
| Bending | | | | |
| on 10 mm panels^{c)} | | | | |
| Film thickness (μm) | 360 | 420 | 430 | 500 |
| Bending in bending shoe | + | + | + | + |
| (4%) | | | | |
| Foam rating | 2 | 3 | 2-3 | 3 |
| CD test on 10 mm | | | | |
| panels^{c)} | | | | |
| (−1.5 volt against | | | | |
| calomel electrode) | | | | |
| Subfilm creep | | | | |
| (mm) after: | | | | |
| 28 days/22° C. | 4 | 3.5-4 | 3.5-4 | 4 |
| 2 days/65° C. | 2.5 | 2.5 | 2 | 2-3 |
| 14 days/65° C. | 4 | 3 | 4 | 3.5-4 |
| 2 days/140° C. | 2-3 | 2 | 2-2.5 | 2-2.5 |
| sand bath | | | | |
| Water storage of 10 mm | | | | |
| panels^{c)} (film thickness | | | | |
| 400 to 500 μm) at | | | | |
| 80° C.; water absorption | | | | |
| (% by weight) after: | | | | |
| 240 hours | 1.71 | 1.76 | 3.87 | 2.30 |
| 504 hours | 2.22 | 2.45 | 4.07 | 2.69 |
| 744 hours | 1.9 | 1.84 | 4.2 | 2.85 |
| 1008 hours | 2.02 | 2.15 | 5.48 | 3.79 |
| Impact^{d)} | | | | |
| on 10 mm panels^{c)} | | | | |
| Point 1: film thickness | 440 | 520 | 430 | 520 |
| (μm) | | | | |
| kg × cm | 50 | 50 | 50 | 50 |
| Point 2: film thickness | 410 | 460 | 450 | 510 |
| (μm) | | | | |
| kg × cm | 60 | 60 | 60 | 60 |
| Point 3: film thickness | 370 | 450 | 340 | 420 |
| (μm) | | | | |
| kg × cm | 70 | 70 | 65 | 65 |
| Point 4: film thickness | 380 | 410 | 410 | 420 |
| (μm) | | | | |
| kg × cm | 80 | 75 | 70 | (70) |
| Point 5: film thickness | 380 | 440 | 370 | 440 |
| (μm) | | | | |
| kg × cm | 80 | 75 | 75 | 65 |
| Point 6: film thickness | 400 | 420 | 400 | 450 |
| (μm) | | | | |
| kg × cm | (90) | 80 | 80 | (65) |
| Point 7: film thickness | 450 | 490 | 430 | 540 |
| (μm) | | | | |
| kg × cm | 70 | (70) | (80) | 60 |
| Point 8: film thickness | 470 | 500 | 450 | 540 |
| (μm) | | | | |
| kg × cm | (75) | 60 | (65) | (60) |

^{a)}determined using Coesfeld geltime instrument;
^{b)}∘ = cracks; x = hairline cracks; + = satisfactory;
^{c)}for preparation, the steel panels were blasted to SA 2.5 state using a GH 40 Wheelabrator; the steel panels were preheated at 240° C., coated, afterbaked at 240° C. for 120 seconds, and immediately cooled in water;
^{d)}impact values without () = satisfactory, no destruction of the coating takes place;
Impact values with () = unsatisfactory, destruction of the coating occurs;
kg × cm = product of the weight of the falling body (sphere diameter 16 mm and weight 1 kg) and height of fall

The results compiled in Table 2 underscore the fact that as well as their high glass transition temperature Tg the inventive coatings 1 to 4 had a high flexibility, mechanical stability, and corrosion resistance, and exhibited only little water absorption.

What is claimed is:

1. A powder coating material comprising, based on the coating material,
(A) from 40 to 65% by weight of at least one solid epoxy resin which is polyfunctional in respect of thermal crosslinking by way of the epoxide groups and has an epoxide equivalent weight of from 380 to 420 g/equ., an ICI melt viscosity at 150° C. of from 2800 to 5000 mPas, and a softening point of from 95 to 105° C.,
(B) from 20 to 35% by weight of at least one solid, linear epoxy resin based on bisphenol A, AD and/or F, having a functionality in respect of thermal crosslinking by way of the epoxide groups of not more than 2,
(C) from 15 to 30% by weight of an inorganic filler and
(D) from 1 to 10% by weight of at least one hardener.

2. The coating material as claimed in claim 1, containing, based on the coating material,
(E) from 0.5 to 10% by weight of at least one inorganic pigment.

3. The coating material as claimed in claim 1 or 2, containing, based on the coating material,
(F) from 0.01 to 2% by weight of at least one typical powder coatings additive.

4. A functional coating for high long-term service temperatures on substrates, producible from a powder coating material as claimed in any of claims 1 to 3 by thermal crosslinking.

5. The functional coating as claimed in claim 4, whose glass transition temperature Tg is from 130 to 150° C.

6. The functional coating as claimed in claim 5, the long-term service temperatures being from 80 to 130° C.

7. The functional coating as claimed in any of claims 4 to 6, which is single-ply.

8. The functional coating as claimed in claim 7, which is from 250 to 1000 μm thick.

9. The functional coating as claimed in any of claims 4 to 6, which forms the primer of a multi-ply coating system.

10. The functional coating as claimed in claim 9, wherein the multi-ply coating system is composed of the primer and at least one coat selected from the group consisting of adhesion promoter coats, polyolefin coats, insulating polyurethane coats, and coats producible from other powder coating materials based on epoxy resins.

11. The functional coating as claimed in claim 10, wherein the multi-ply coating is composed of the primer, an adhesion promoter coat, and a polyolefin coat.

12. The functional coating as claimed in any of claims 4 to 11, wherein the substrates are steel pipes.

13. A powder coating material comprising, based on the coating material,
(A) from 40 to 65% by weight of at least one solid epoxy resin which is polyfunctional in respect of thermal crosslinking by way of the epoxide groups and has an epoxide equivalent weight of from 380 to 420 g/equ., an ICI melt viscosity at 150° C. of from 2800 to 5000 mPas, and a softening point of from 95 to 105° C.,
(B) from 20 to 35% by weight of at least one solid, linear epoxy resin comprising a reaction product of at least one of bisphenol A, bisphenol AD, and bisphenol F, and having a functionality in respect of thermal crosslinking by way of the epoxide groups of not more than 2,
(C) from 15 to 30% by weight of an inorganic filler and
(D) from 1 to 10% by weight of at least one hardener.

14. The coating material of claim 13 further comprising, based on the coating material,
(E) from 0.5 to 10% by weight of at least one inorganic pigment.

15. The coating material of claim 13 further comprising, based on the coating material,
(F) from 0.01 to 2% by weight of at least one powder coatings additive.

16. A coating on a substrate produced from the powder coating material of claim 13 by thermal crosslinking.

17. The coating of claim 16, wherein the coating has a glass transition temperature Tg from 130 to 150° C.

18. The coating of claim 17, wherein the coating has a long-term service temperatures of from 80 to 130° C.

19. The coating of claim 16, wherein the coating is single-ply.

20. The coating of claim 19, wherein the coating has a thickness from 250 to 1000 μm.

21. The coating of claim 16, wherein the coating is a primer of a multi-ply coating system.

22. The coating of claim 21, wherein the multi-ply coating system is composed of the primer and at least one coat selected from the group consisting of an adhesion promoter coat, a polyolefin coat, an insulating polyurethane coat, and a coat producible from another powder coating material based on an epoxy resin.

23. The coating of claim 22, wherein the multi-ply coating comprises the primer, an adhesion promoter coat, and a polyolefin coat.

24. The coating of claim 16, wherein the substrate is a steel pipe.

25. A coating on a substrate produced from the powder coating material of claim 14 by thermal crosslinking.

26. The coating of claim 25, wherein at least one of:
a) the coating has a glass transition temperature Tg from 130 to 150° C.;
b) the coating has a long-term service temperatures of from 80 to 130° C.;
c) the coating is single-ply;
d) the coating has a thickness from 250 to 1000 μm;
e) the coating is a primer of a multi-ply coating system; and
f) the substrate is a steel pipe.

27. The coating of claim 26, wherein the multi-ply coating system is composed of the primer and at least one coat selected from the group consisting of an adhesion promoter coat, a polyolefin coat, an insulating polyurethane coat, and a coat producible from another powder coating material based on an epoxy resin.

28. The coating of claim 27, wherein the multi-ply coating comprises the primer, an adhesion promoter coat, and a polyolefin coat.

29. A coating on a substrate produced from the powder coating material of claim 15 by thermal crosslinking.

30. The coating of claim 29, wherein at least one of:
a) the coating has a glass transition temperature Tg from 130 to 150° C.;
b) the coating has a long-term service temperatures of from 80 to 130° C.;
c) the coating is single-ply;
d) the coating has a thickness from 250 to 1000 μm;
e) the coating is a primer of a multi-ply coating system; and
f) the substrate is a steel pipe.

31. The coating of claim 30, wherein the multi-ply coating system is composed of the primer and at least one coat selected from the group consisting of an adhesion promoter coat, a polyolefin coat, an insulating polyurethane coat, and a coat producible from another powder coating material based on an epoxy resin.

32. The coating of claim 31, wherein the multi-ply coating comprises the primer, an adhesion promoter coat, and a polyolefin coat.
